(19) United States
(12) Patent Application Publication
(10) Pub. No.: US 2014/0278225 A1
(43) Pub. Date: Sep. 18, 2014

(54) DETERMINING CHANGES IN PHYSICAL LOCATION BASED ON THE OBSERVED MAGNETIC FIELD

(71) Applicant: Novatel Wireless, Inc., San Diego, CA (US)

(72) Inventors: Calvin Gerard French, Plano, TX (US); Charles Chapman Moore, Plano, TX (US)

(73) Assignee: Novatel Wireless, Inc., San Diego, CA (US)

(21) Appl. No.: 13/797,430

(22) Filed: Mar. 12, 2013

(51) Int. Cl. G01B 7/14

(52) U.S. Cl. CPC G01B 7/14
USPC 702/153; 324/207.13

(57) ABSTRACT

Systems and methods for determining whether a device has moved based upon sensed changes to the observed magnetic field are disclosed herein. Various embodiments function on the principle that it is highly unlikely that the observed magnetic field will be the same in any two given locations (at least, when the observed magnetic field is measured in three dimensions), and moreover, it is unlikely that the observed magnetic field will change if the device remains stationary. Various embodiments therefore include one or more magnetic sensors (e.g., a compass) disposed within the device. The device can be configured to periodically check its current reading of the observed magnetic field. If the device determines that its magnetic reading has changed relative to its last reading, a possible or actual relocation event can then be declared.

### BACKGROUND

1. Field of the Invention

The embodiments described herein relate generally to the field of location detection, and more particularly, to determining whether a device has moved based upon changed readings of the observed magnetic field.

2. Related Art

A wide variety of software applications rely on location sensing/motion sensing in order to determine whether a given device (such as a smart-phone, personal data assistant, GPS sensor in an automobile, or other device) has moved. These applications include GPS tracking devices, electronic maps, utilities, games, as well as other specialized applications.

There are several conventional methods for determining whether a given device has moved. For example, some devices utilize accelerometers, gyroscopes, and/or other types of internal motion/tilt detectors to continually report a device's current position/orientation. One problem with this approach (which is particularly noticeable in battery-operated handheld devices) is that the more frequently a device polls its own position/orientation, the more power becomes consumed in the process. Therefore, conventional location/motion sensing processes which continually monitor a device's position/orientation can quickly drain the batteries powering the device.

In order to extend the device's battery life, many handheld devices on the market today now utilize systems where the motion sensing occurs less frequently. Recurring periods of inactivity known as “power save periods” have been introduced into a device's normal cycles of operation. During these “power save periods,” no motion sensing occurs. Although such “power save periods” can serve to extend the battery life of a handheld device (and consequently, reduce the frequency of recharging operations that need to be performed), they also introduce a different problem in that if the device should happen to be moved during a power save period, no movement will be detected by the system.

A second technique for location/motion sensing involves “triangulation,” i.e., using two known coordinates to determine the location of a third. This technique is currently used in GPS tracking as well as in cellular communications. For example, FIG. 1 is a block diagram illustrating a conventional network configuration used for cellular triangulation as known in the prior art. As depicted in the figure, a handheld device 102 (e.g., a smart phone) can receive transmitted signals 105 from two or more receiving stations 108(1), 108(2) . . . 108(n). These receiving stations 108(1), 108(2) . . . 108(n) can be connected over a local or wide area network 110 and communicate with one or more servers 112. Upon receipt of the transmitted signals 105, the handheld device 102 can then issue response signals 106 to each of the respective receiving stations 108(1), 108(2) . . . 108(n). The approximate distance between a given receiving station 108 and the handheld device 102 can then be calculated based upon the round-trip signal time and/or the received signal strength detected at a receiving station 108. A range of possible points can then form a circular band, with radii extending outward from each receiving station 108(1), 108(2) . . . 108(n). The position at which the distal ends of the radii overlap can thus be used to pinpoint the specific location of the handheld device 102.

Triangulation, however, brings with it its own set of associated issues. Not only does triangulation require substantial amounts of power to properly function (as the handheld device 102 needs to transmit and/or receive a signal that is strong enough to be read by at least two nearby cell towers/satellites), but various other problems can be associated with this technique as well. For example, GPS devices typically require a clear view of the sky for the system to function at satisfactory performance levels. However, in the real world, these conditions are not always present, either due to inclement weather conditions or due to the existence of various overhead structures in large metropolitan areas, for example. Additionally, cell tower triangulation typically utilizes at least three separate antenna towers in order to determine a device's location. While this is usually not an issue in urban areas where a multitude of cell towers are present, in various rural areas which are more sparsely populated, cell tower triangulation may simply not be possible due to the fact that fewer cell towers are present.

### SUMMARY

Various embodiments described herein are directed to determining whether a device has moved using magnetic sensors dispensed within the device based upon changed readings of the observed magnetic field.

In various embodiments, the magnetic field being observed is typically generated by the Earth. It should be noted, however, that it can also be generated and/or modified by a number of surrounding objects such as magnets and metal.

It should also be noted that changes in magnetic fields can be defined as changes across a three dimensional, orthogonal axes, measurement, an absolute measurement, a direction of strongest field, or some other mechanism.

In a first exemplary aspect, a method for electronically determining whether an entity has moved is disclosed. In one embodiment, the method comprises: generating a first reading of an observed magnetic field, said first reading being generated by at least one magnetic sensor disposed within an electronic module coupled with the entity; generating a second reading of the observed magnetic field, said second reading being generated by said at least one magnetic sensor; electronically processing the first reading and the second reading in order to detect whether a difference exists between the first reading and the second reading; and generating a signal if a difference is detected.

In a second exemplary aspect, an electronic module for determining whether an entity has moved is disclosed. In one embodiment, the electronic module comprises: a processor adapted to execute a set of instructions; memory coupled to the processor, wherein the memory is adapted to store a set of instructions; at least one magnetic sensor adapted to generate readings of the observed magnetic field, and a first set of instructions disposed within the memory, the first set of instructions adapted to compare a first reading and a second reading of the observed magnetic field, the first set of instructions further adapted to generate a signal if a difference between the first reading and the second reading is detected.

In a third exemplary aspect, a computer-readable medium is disclosed. In one embodiment, the computer-readable medium comprises: generating a first reading of the observed magnetic field, said first reading being generated by at least one magnetic sensor; generating a second reading of the observed magnetic field, said second reading being generated by said at least one magnetic sensor; electronically processing the first reading and the second reading in order to detect whether a difference exists between the first reading and the second reading; and generating a signal if a difference is detected.

Other features and advantages should become apparent from the following description of the preferred embodiments, taken in conjunction with the accompanying drawings, which illustrate, by way of example, the principles of the invention.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration these drawings are not necessarily made to scale.

FIG. 1 is a block diagram illustrating a conventional network configuration used for device triangulation as known in the prior art.

FIG. 2 is a block diagram illustrating an exemplary handheld device which utilizes one or more magnetic sensors to determine whether the device has moved according to one embodiment.

FIG. 3 is a flow diagram illustrating an exemplary process for signaling a location change according to one embodiment.

The various embodiments mentioned above are described in further detail with reference to the aforementioned figured and the following detailed description of exemplary embodiments.

### DETAILED DESCRIPTION

In the following detailed description, reference is made to the accompanying drawings in which like references indicate similar elements, and in which is shown by way of illustration. These embodiments are described in sufficient detail to enable those of ordinary skill in the art to practice the invention as claimed. The following detailed description is therefore not to be taken in a limiting sense.

Various embodiments described herein function on the principle that it is highly unlikely that the observed magnetic field will be the same in any two given locations (at least, when the observed magnetic field is measured in three dimensions), and moreover, it is unlikely that the observed magnetic field will change if the device remains stationary. Various embodiments therefore include one or more magnetic sensors (e.g., a compass) disposed within the device. The device can be configured to periodically check its current reading of the observed magnetic field present at the device. If the device determines that its magnetic reading has changed relative to its last reading, a possible or actual relocation event can then be declared.

It should be noted that presence of metallic or magnetic material in proximity of the sensor can modify the observed magnetic field. This modification, however, remains constant until either the other object is located or the device is located. For this reason, various exemplary algorithms disclosed herein allow for detection of a change in the device environment, either by relocating items in proximity to the device, or by relocating the device itself. This also demonstrates the importance of monitoring both the magnitude and the direction of observed magnetic fields.

It should also be noted that changes in magnetic fields can be defined as changes across a three dimensional, orthogonal axes, measurement, an absolute measurement, a direction of strongest field, or by some other mechanism. While usage of a three dimensional measurement oriented to the surface of the earth may provide the best results for an asset tracking implementation, other measures can also be used. This includes, without limitation: Absolute magnitude, which can be measured at lower cost; direction of strongest field as oriented to the earth surface (for example, if a simple compass is available); and three dimensional measurements when orientation is not matched to the earth. In many instances, the latter can be less computationally intensive while still providing acceptable performance.

Accordingly, the embodiments described herein provide reliable location detection as well as reliable detection of changes in position by sensing the observed magnetic field at the device's current location and comparing it to the previously sensed value. Such a technique can be used, for example, as a stand-alone feature for independently determining whether the device has been moved. Alternatively, such a technique can be used in conjunction with other position sensing/motion sensing techniques, such as an event trigger for altering the power state of a different position/motion sensor, or in lieu of/in addition to a portion of a normal device cycle, such as the “power save periods” referenced above.

In some embodiments, the device can include one or more magnetic sensors, e.g., a compass, for detecting the current direction and amplitude of the observed magnetic field. Because the positional plane/orientation of the device can vary with normal use, the magnetic sensor(s) in the device can detect the direction and amplitude of the observed magnetic field over three separate dimensions, e.g., as defined by orthogonal x, y, and z axes, according to some embodiments.

A snapshot of the observed magnetic field can first be taken by the device's magnetic sensor(s). The device can then periodically take a new snapshot of the observed magnetic field to determine if a change has been detected. In some embodiments, the period between snapshots can be specified as input from a user in order to optimize power consumption levels. The input can be directly programmed into the device, or it can be received from a remote server application in the alternative. Optionally, one or more thresholds can also be used to ensure that the change in magnetic field significant. Then, if a significant change in the sensed magnetic field has been detected, a location change or a possible location and/or environment change can be subsequently declared by the system. In some embodiments, further validation can then be performed by other location determining mechanisms. As stated above, such devices function on the principle that it is highly unlikely that the observed magnetic field will be the same in any two given locations and moreover, it is unlikely that the observed magnetic field will change if the device remains in a stationary environment. Therefore, when the device determines that a subsequent reading of the observed magnetic field differs from that of the previous reading, the device has likely been moved from its prior location.

FIG. 2 is a block diagram illustrating an exemplary handheld device which utilizes one or more magnetic sensors to determine whether it has moved according to one embodiment. As illustrated by FIG. 2, the exemplary handheld device 200 can include a power supply unit 202, one or more processors 204, memory 206, a network interface module 208, an accelerometer 210, and one or more magnetic sensors 212. A location change algorithm 207 can also be resident within memory 206.

The power supply unit 202 provides a source of power to the various electronic modules electrically disposed within the handheld device 200. In some embodiments, power can be supplied externally by one or more conductive wires, for example, via a power or serial bus cable. In other embodiments, a battery can be used as a source of power.

One or more processors 204 are adapted to execute sequences of instructions by loading and storing data to the memory 206. Possible instructions include, without limitation, instructions for data conversions, formatting operations, communication instructions, and/or storage and retrieval operations. Additionally, the one or more processors 204 can comprise any type of digital processing devices including, for example, reduced instruction set computer processors, general-purpose processors, microprocessors, digital signal processors, gate arrays, programmable logic devices, array processors, and/or application-specific integrated circuits. Note that the one or more processors 204 can be contained on a single unitary IC die or distributed across multiple components.

Memory 206 comprises any type of module or modules adapted to enable digital information to be stored, retained, and subsequently retrieved. Memory 206 can comprise any combination of volatile and non-volatile storage devices, including without limitation RAM, DRAM, SRAM, ROM, and/or flash memory. Note also that the memory 206 can be organized in any number of architectural configurations utilizing, for example, registers, memory caches, data buffers, main memory, mass storage, and/or removable media.

Network interface module 208 is a module for communicatively interfacing handheld device 200 with one or more remote nodes disposed within a network. Any type of networking medium and/or networking protocols can be used for this purpose (e.g., cellular networks, fiber-optic networks, cable networks, satellite networks, wireless networks, serial bus networks, etc.). Additionally, a wide variety of network topologies or arrangement can also be employed. This includes, without limitation, personal area networks, metropolitan area networks, wide area networks (e.g., the Internet), direct connection networks, star networks, ring networks, as well as other configurations.

While a conventional module for location/motion sensing is depicted at accelerometer 210, it will be understood that the one or more magnetic sensors 212 can operate independently of such modules, and thus, inclusion of the accelerometer 210 (or other such location/motion sensing modules) is optional according to embodiments. In conventional systems, accelerometers operate by measuring the accelerative forces acting upon an object. Thus, accelerometers embedded within the handheld device 200 can be useful in location/motion sensing, although continual use of such devices can rapidly drain the battery in the power supply unit for reasons already mentioned above. Note that other forms of location/motion sensing (e.g., electromechanical gyrocscopes, optical gyroscopes, tilt detection devices, etc.) can be used in addition to or in lieu of the depicted accelerometer 210.

The one or more magnetic sensors 212 can be used to periodically generate a snapshot or reading of the observed magnetic field. In some embodiments, each reading of the observed magnetic field can be taken across three dimensions defined by orthogonal axes. Note that the various readings taken by the one or more magnetic sensors 212 can be read by one or more processors 204 and stored into memory 206 accordingly. In other embodiments, the magnetic sensors can write their recorded readings directly into memory 206.

A location change algorithm 207 resident in memory 206 can be used to signal a change in the present location of the handheld device 200 according to some embodiments. For example, FIG. 3 is a flow diagram illustrating an exemplary process for signaling a location change according to one embodiment.

At block 302, the one or more magnetic sensors 202 can detect the magnetic field at the handheld device's present position. Next, at block 304, a comparison can be made between the detected magnetic field in the most recent reading and the detected magnetic field in the previous reading. Optionally, one or more thresholds can be utilized in order to ensure that the detected change in readings is significant. If no significant change has been detected, control can pass back to block 302. However, if a significant change has been detected, a potential location change can be signaled at block 306.

For example, a “wake-up” command might be issued to a conventional location/motion sensing module, followed by an instruction to confirm or validate whether the location of the handheld device has in fact changed. In embodiments where no conventional location/motion sensing modules are present, an actual location change can be signaled in the alternative (i.e., control can simply pass from block 304 to block 310).

Otherwise, the conventional location/motion sensing module will attempt to validate the location change at block 308. If the location change can be successfully validated by the conventional location/motion sensing module, then a location change can be signaled at block 310. Otherwise, control can resume at block 302, and then the process repeats. Note that in some embodiments, all or a portion of the validation can be performed using more power consuming options such as GPS and/or other triangulation techniques mentioned above.

While various embodiments depicted above generally relate to a handheld device such as a smart phone with device-tracking capability, it will be understood that the possible embodiments are in no way limited to handheld devices, and that certain embodiments can also be used within myriad other contexts, devices (e.g., asset tracking), as well as other applications. For example, such devices can be attached to toxic containers, classified materials, or even living organisms (e.g., animals or people) in order to detect escape or movement from a confined area. As another example, such devices can be attached to unmanned vehicles, ships, or projectiles in order to assist with position, velocity, or acceleration detection.

While various embodiments have been described above, it should be understood that they have been presented by way of example only, and not of limitation. The breadth and scope as claimed should not be limited by any of the above-described exemplary embodiments. Where this document refers to technologies that would be apparent or known to one of ordinary skill in the art, such technologies encompass those apparent or known to the skilled artisan now or at any time in the future. In addition, the invention as claimed is not necessarily restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features described herein.

Furthermore, although items, elements or components of the invention can be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for electronically determining whether an entity has moved, the method comprising:
generating a first reading of an observed magnetic field, said first reading being generated by at least one magnetic sensor disposed within an electronic module coupled with the entity;
generating a second reading of the observed magnetic field, said second reading being generated by said at least one magnetic sensor;
electronically processing the first reading and the second reading in order to detect whether a difference exists between the first reading and the second reading; and
generating a signal if a difference is detected.

2. The method of claim 1, wherein said at least one magnetic sensor is adapted to generate each of said readings across three dimensions defined by orthogonal axes.

3. The method of claim 1, wherein the signal is adapted to trigger an alternative location determination algorithm.

4. The method of claim 3, wherein the alternative location determination algorithm is GPS.

5. The method of claim 1, wherein the entity is associated with an asset.

6. The method of claim 1, further comprising waiting a predetermined period before generating the second reading, wherein the predetermined period is defined by an input provided by a user to the electronic module.

7. The method of claim 6, wherein the input is programmed directly into the electronic module.

8. The method of claim 6, wherein the input is provided to the electronic module via a remote server application.

9. The method of claim 1, wherein electronically processing the first reading and the second reading in order to determine whether a difference exists further comprises evaluating one or more thresholds.

10. An electronic module for determining whether an entity has moved, the electronic module adapted to be electrically or physically coupled with the entity, the electronic module comprising:
a processor adapted to execute a set of instructions;
memory coupled to the processor, wherein the memory is adapted to store a set of instructions;
at least one magnetic sensor adapted to generate readings of the observed magnetic field, and
a first set of instructions disposed within the memory, the first set of instructions adapted to compare a first reading and a second reading of the observed magnetic field, the first set of instructions further adapted to generate a signal if a difference between the first reading and the second reading is detected.

11. The electronic module of claim 10, wherein the at least one magnetic sensor is adapted to generate readings of the observed magnetic field across three dimensions defined by orthogonal axes.

12. The electronic module of claim 10, further comprising a second set of instructions disposed within the memory, wherein the second set of instructions is adapted to trigger an alternative location determination algorithm upon detection of the signal generated by the first set of instructions.

13. The electronic module of claim 12, wherein the alternative location determination algorithm is GPS.

14. The electronic module of claim 10, wherein the entity is associated with an asset.

15. The electronic module of claim 10, wherein the first set of instructions further comprises receiving an input provided by a user, wherein the input is adapted to specify a delay period between generating subsequent readings of the observed magnetic field.

16. The electronic module of claim 15, wherein the input is adapted to be programmed directly into the electronic module.

17. The electronic module of claim 15, wherein the input is adapted to be provided to the electronic module via a remote server application.

18. The electronic module of claim 10, wherein generating a signal if a difference is detected further comprises evaluating one or more thresholds.

19. A computer-readable medium containing instructions which, when executed by a computer, perform a process comprising:
generating a first reading of the observed magnetic field, said first reading being generated by at least one magnetic sensor;
generating a second reading of the observed magnetic field, said second reading being generated by said at least one magnetic sensor;
electronically processing the first reading and the second reading in order to detect whether a difference exists between the first reading and the second reading; and
generating a signal if a difference is detected.

20. The computer-readable medium of claim 19, wherein said at least one magnetic sensor is adapted to generate each of said readings across three dimensions defined by orthogonal axes.
